(19) United States
(12) Patent Application Publication
(10) Pub. No.: US 2011/0203545 A1
(43) Pub. Date: Aug. 25, 2011

(54) Method For Manufacturing A Piston Of An Internal Combustion Engine, Comprising An Improved Aluminum Silicon Alloy

(75) Inventor: Udo Buschkamp, Hausen o.V. (DE)

(73) Assignee: KS KOLBENSCHMIDT GMBH, Neckarsulm (DE)

(21) Appl. No.: 13/062,476

(22) PCT Filed: Sep. 3, 2009
(86) PCT No.: PCT/EP2009/006393

§ 371 Date: May 12, 2011

(30) Foreign Application Priority Data
Sep. 5, 2008 (US) 10 2008 045 800.7

(51) Int. Cl. F02F 3/00; B23P 15/10

(52) U.S. Cl. 123/193.6; 29/888.04

(57) ABSTRACT

The invention relates to a process for producing a piston of an internal combustion engine, wherein a piston blank is cast from an alloy of aluminium and silicon with the addition of copper fractions and is then finished, wherein the invention provides that the maximum fraction of copper in the alloy, of aluminium and silicon is 5.5%, and that fractions of titanium (Ti), zirconium (Zr), chromium (Cr) or vanadium (V) are admixed with the alloy of aluminium and silicon.

### BACKGROUND

The presently disclosed process relates to a process for producing a piston of an internal combustion engine, wherein a piston blank is cast from an alloy of aluminium and silicon.

Owing to ever increasing injection pressures and, associated therewith, ever increasing combustion temperatures, the pistons operated in modern internal combustion engines are exposed to ever higher stresses, and therefore it is fundamentally necessary to take measures to improve the strength of these pistons.

One possible measure for improving the strength of pistons is that of producing the piston using a forging process. Although the desired requirements in terms of strength can be satisfied by the forging process, the complex structural shapes of modern pistons, in particular pistons made from a light metal material, cannot be realized using forging processes.

The other possible way to produce a piston, with which the desired complex shapes can be obtained, is the casting process, wherein pistons are produced from light metal materials preferably by using an alloy of aluminium and silicon, which is introduced as molten material into a casting mold, where it solidifies, wherein a piston blank can then be removed from the casting mold and is finished. The finishing generally involves dimensioning of the piston blank by material-removing machining, e.g. turning or milling, and the introduction of other elements (e.g. annular grooves, pin holes, inlet and outlet openings for a cooling duct in the piston and the like). The finished piston is then available and can be installed in the internal combustion engine.

In the case of the casting processes known to date for producing pistons from light metal materials, an expensive double heat treatment (solution annealing) is additionally necessary, but this does not lead to the desired strength properties of the finished piston.

It would be desirable to increase the performance in terms of strength of a piston made by a process for producing a piston in which a piston blank is cast from an alloy of aluminium and silicon.

In order to increase the performance of a piston in terms of strength, the admixture of copper fractions with an alloy of aluminium and silicon has already been disclosed the strength of the finished piston has not yet satisfactory taken into account the underlying conditions during the operation thereof in the cylinder space of the internal combustion engine.

A motor-driven sliding pairing made from an aluminium-based alloy is known from DE 10 2005 047 037 A1.

It would, therefore, be desirable to provide a process based on the desirability of specifying an improved process for producing a piston of an internal combustion engine, wherein a piston produced by this process has a considerably improved performance in terms of strength during operation in the cylinder of the internal combustion engine.

### SUMMARY

The disclosed process provides that the maximum fraction of copper in an alloy of aluminium and silicon is 5.5%, and that fractions of titanium, zirconium, chromium or vanadium, are admixed with the alloy of aluminium and silicon and the sum total of all constituents (including possible impurities) is 100%. The use of such a piston alloy has the advantage that it is thereby possible to achieve high fatigue strengths of the finished piston in the cylinder space of the internal combustion engine at high temperatures, i.e. under full load, and at medium temperatures, i.e. under partial load of the internal combustion engine. A further advantage is that the constituents of the piston alloy can easily be combined, this being a decisive advantage for the series production of pistons.

### DETAILED DESCRIPTION

According to one aspect, phosphorus is added to the alloy of aluminium and silicon. This has the advantage that the grain refining effect is improved and also better flow properties are established. These properties show their optimum action in interaction with the other fractions in the piston alloy particularly when the fraction of phosphorus is 40-80 ppm.

In one aspect, beryllium-vanadium is added to the piston alloy. This addition of beryllium-vanadium advantageously reduces the formation of oxides, in particular on the surface of the piston blank or of the finished piston.

According to another aspect, titanium-boron is added to the piston alloy. This addition of titanium-boron also improves the grain refining effect (i.e. the number of nuclei in the molten material is increased by the introduction of material) and additionally reduces the formation of feather crystals (feather crystals being grains which float freely and solidify in a manner isolated from the solidification front) in the microstructure of the material of the cast piston blank, which otherwise leads to material weakening.

In another aspect, phosphorus, beryllium-vanadium and titanium-boron can be added to the piston alloy in any combination, such as phosphorus and beryllium-vanadium, phosphorus and titanium-born, beryllium-vanadium and titanium-boron, and phosphorus, beryllium-vanadium and titanium-boron.

According to another aspect, the finished piston made according to any of the different combinations of phosphorus, beryllium-vanadium and titanium-boron, as described above, is subjected to the Al-Fin process, beryllium-vanadium being added to the material for the Al-Fin process. The addition of beryllium-vanadium to the Al-Fin material improves the bonding thereof to the surface of the piston and additionally advantageously reduces the sludge layer.

Overall, the disclosed process for producing the piston using the claimed piston alloy affords a higher fatigue strength compared to pistons produced by known casting processes; the fatigue strength being increased by at least 15% compared to the fatigue strength known to date, measured at room temperature and at 350° C. This results in a higher load-bearing capacity of the piston during operation of the internal combustion engine, accompanied by a considerable reduction in weight. It is likewise possible to achieve higher material hardnesses, as a result of which it is advantageously possible to dispense with the heat treatment (solution annealing) of the cast piston blank or of the piston being finished which has always been carried out to date.

The attached table shows various alloys from the prior art and the compositions thereof (M124, M142, M145, M174 from Mahle GmbH and also KS1295 from KS Kolbenschmidt GmbH) with the alloy according to the invention, which bears the name “Timbor”, and the composition thereof. The numbers in the columns of the table are percentages and relate to the percentage of the respective material, based on the overall quantity thereof.

1. Process for producing a piston of an internal combustion engine, wherein a piston blank is cast from an alloy of aluminium and silicon with the addition of copper fractions and is then finished, characterized in that the maximum fraction of copper in the alloy of aluminium and silicon is 5.5%, and in that fractions of titanium (Ti), zirconium (Zr), chromium (Cr) or vanadium (V) are admixed with the alloy of aluminium and silicon and the sum total of all constituents is 100%.

2. Process according to claim 1, characterized in that phosphorus (P) is added to the alloy of aluminium and silicon.

3. Process according to claim 2, characterized in that the fraction of phosphorus in the piston alloy is 40-80 ppm.

4. Process according to one of the preceding claims, characterized in that beryllium-vanadium (BeV) is added to the alloy of aluminium and silicon.

5. Process according to one of the preceding claims, characterized in that titanium-boron (TiB) is added to the alloy of aluminium and silicon.

6. Process according to one of the preceding claims, characterized in that the finished piston is subjected to the Al-Fin process, beryllium-vanadium (BeV) being added to the material for the Al-Fin process.

7. Piston of an internal combustion engine, produced by the process according to one of the preceding claims.

8. Piston according to claim 7, characterized in that the piston comprises a top piston part with an annular field and, if appropriate, a combustion chamber cavity and, if appropriate, a cooling duct and also a bottom part with piston shanks and pin holes.

9. Piston according to either of claims 7 and 8, characterized in that the top part of the piston comprises a cooling duct, wherein the cooling duct is provided with at least one inlet opening and at least one outlet opening for a cooling medium, wherein the cooling medium, in particular engine oil, is injected into the at least one inlet opening, circulates in the cooling duct and exits from the outlet opening and, as it exits, dissipates heat from the top piston part.

10. The process according to claim 1, characterized in that phosphorous and beryllium-vanadium (Bev)are added to the alloy of aluminium and silicon.

11. The process according to claim 10, characterized in that titanium-boron (TiB) is added to the alloy of aluminium and silicone.

12. The process according to claim 1, characterized in that phosphorous (P) and titanium-boron (TiB) are added to the alloy of aluminium and silicone.

13. The process according to claim 1, characterized in that beryllium-vanadium (Bev) and titanium-boron (TiB) are added to the alloy of aluminium and silicone.

14. The process according to claim 2, characterized in that the finish piston is subjected to the Al-Fin process, beryllium-vanadium (BeV) being added to the alloy for the Al-Fin process.

15. The process according to claim 4, characterized in that the finish piston is subjected to the Al-Fin process, beryllium-vanadium (BeV) being added to the alloy for the Al-Fin process.

16. The process according to claim 5, characterized in that the finish piston is subjected to the Al-Fin process, beryllium-vanadium (BeV) being added to the alloy for the Al-Fin process.
